(19) United States
(12) Patent Application Publication
(10) Pub. No.: US 2026/0242295 A1
(43) Pub. Date: Aug. 20, 2026

(54) FORMULATION AND METHOD FOR PREPARING FLEXIBLE CERAMIC NANOFIBERS FOR THERMAL INSULATION APPLICATIONS

(71) Applicant: Jazze Marie Gorman, Houston, TX (US)

(72) Inventor: Jazze Marie Gorman, Houston, TX (US)

(21) Appl. No.: 19/056,905

(22) Filed: Feb. 19, 2025

(51) Int. Cl. C04B 35/622; C04B 35/626; C04B 35/634; D01D 5/00; D01D 10/02

(52) U.S. Cl. CPC C04B 35/62259; C04B 35/62675; C04B 35/63488; D01D 5/0007; D01D 10/02; C04B 2235/3232; C04B 2235/61; D10B 2101/08

(57) ABSTRACT

The present disclosure relates to a formulation and method for preparing flexible ceramic nanofibers for thermal insulation applications (100) comprising a titanium-containing precursor comprising reactive functional groups, including terminal alkenes, present in a molar ratio of 50-70% relative to the total precursor solution, facilitating further radical polymerization and segment integration. The formulation (100) comprising a silicon-containing precursor comprising hydrolysable alkoxy groups, contributing to enhanced thermal resistance and flexibility, a polymeric binder selected from polyethylene oxide, providing spinnability and structural uniformity during electrospinning, a solvent system comprising alcohol-based solvents and glacial acetic acid, promoting solubility and homogeneity of the components, wherein upon processing through electrospinning and subsequent heat treatment, produces nanofibrous membranes with low thermal conductivity, high tensile strength, and adaptability for thermal insulation applications in aerospace, electronics, and flexible insulation fields.

### FIELD OF THE INVENTION

Embodiments of the present invention relate to the field of thermal insulation and specifically relates to a formulation and method for preparing flexible ceramic nanofibers for thermal insulation applications.

### DESCRIPTION OF THE RELATED ART

The formulation and method provide a versatile material that seamlessly blends flexibility and durability, making it suitable for an extensive range of insulation applications. Unlike rigid or brittle materials, this invention allows for easy adaptation to complex shapes and surfaces, enabling efficient use across diverse industrial, residential, and commercial setups. This flexibility also reduces the risk of material damage during handling, installation, or use, ensuring cost savings and enhanced convenience for end users.

The ceramic nanofibers developed through this method are remarkably lightweight, which not only simplifies transportation but also minimizes labor requirements during installation. Industries that rely on heavy insulation materials often face logistical and ergonomic challenges, and this invention alleviates these issues, making it ideal for scenarios where weight restrictions or accessibility limitations exist. This lightweight property makes the material a preferred choice for modern applications demanding both efficiency and practicality.

The method employed in this invention guarantees consistent quality during production, a significant advantage in large-scale manufacturing. Consistency ensures that each batch delivers the same level of performance and reliability, eliminating concerns about variability. By addressing this critical industry requirement, the invention empowers manufacturers to produce high-quality products efficiently while reducing waste and ensuring consumer satisfaction with dependable results.

The material exhibits exceptional reliability even under extreme conditions, ensuring it performs consistently where other insulation solutions fail. This resilience translates into long-term savings for users, as frequent replacements and repairs become unnecessary. Whether used in challenging environments or in day-to-day applications, the product's ability to withstand harsh conditions ensures peace of mind for end users, setting a new standard for reliability in insulation solutions.

The invention offers a sustainable solution by promoting efficient resource utilization, reducing environmental impact, and ensuring a longer lifecycle for insulation products. This durability minimizes the need for constant replacements, reducing waste generation and conserving resources. Moreover, by extending the product's lifespan, users can significantly reduce the total cost of ownership, further establishing its position as an environmentally responsible and cost-effective innovation.

Many existing insulation materials lack the flexibility required for effective use in diverse environments. Their rigidity makes them unsuitable for irregularly shaped surfaces, forcing users to resort to time-consuming and costly adjustments. This lack of adaptability limits their application potential, especially in industries requiring innovative and customized solutions for modern challenges.

Traditional insulation materials are often heavy, making them difficult to transport, handle, and install. The additional weight can lead to higher transportation costs, increased physical strain during installation, and challenges in reaching areas that are hard to access. This inherent heaviness often restricts the use of such materials to specific industries and locations, reducing their overall versatility and practicality.

Existing insulation solutions are prone to inconsistency in production quality, leading to unpredictable performance and reliability issues. These variations can result in materials that fail to meet required standards, causing operational disruptions and additional expenses for replacements or repairs. In industries that depend on uniformity and precision, such inconsistencies create significant obstacles, diminishing confidence in their long-term application.

Many conventional insulation materials are not designed to withstand extreme conditions, making them susceptible to rapid degradation when exposed to high temperatures, moisture, or mechanical stress. This leads to frequent replacements, higher maintenance costs, and reduced efficiency over time. The inability of these materials to perform consistently under challenging conditions highlights a critical gap in existing solutions, limiting their applicability and dependability.

In conclusion, the present invention overcomes the limitations of existing insulation materials by offering a solution that combines flexibility, lightweight properties, and long-term reliability. While traditional materials are hindered by rigidity, heaviness, inconsistency, and poor resistance to extreme conditions, this invention addresses these drawbacks with an innovative approach that ensures superior performance across a wide range of applications. By delivering consistent quality, sustainability, and ease of use, the invention stands out as a transformative advancement, setting a new benchmark for the future of thermal insulation solutions.

Thus, there is a need of a formulation and method for preparing flexible ceramic nanofibers for thermal insulation applications.

Therefore, the present invention provides a formulation and method for preparing flexible ceramic nanofibers for thermal insulation applications.

### SUMMARY OF THE INVENTION

Embodiments of the present invention relate to a formulation for preparing flexible ceramic nanofibers for thermal insulation applications. The formulation comprising a titanium-containing precursor comprising reactive functional groups, including terminal alkenes, present in a molar ratio of 50-70% relative to the total precursor solution, facilitating further radical polymerization and segment integration. The formulation also comprising a silicon-containing precursor comprising hydrolysable alkoxy groups, contributing to enhanced thermal resistance and flexibility. The formulation also comprising a polymeric binder selected from polyethylene oxide, providing spinnability and structural uniformity during electrospinning. The formulation also comprising a solvent system comprising alcohol-based solvents and glacial acetic acid, promoting solubility and homogeneity of the components, wherein upon processing through electrospinning and subsequent heat treatment, produces nanofibrous membranes with low thermal conductivity, high tensile strength, and adaptability for thermal insulation applications in aerospace, electronics, and flexible insulation fields.

In accordance with an embodiment of the titanium-containing precursor constitutes 30-40% by weight of the total formulation, ensuring optimal thermal stability and mechanical performance.

In accordance with an embodiment of the present invention, the silicon-containing precursor constitutes 15-20% by weight of the total formulation, enhancing structural flexibility and insulation properties.

In accordance with an embodiment of the present invention, the polymeric binder comprises polyethylene oxide, present in an amount of 0.5-1.5% by weight, ensuring uniform fibre formation during electrospinning.

In accordance with an embodiment of the present invention, the solvent system, including methanol and glacial acetic acid, constitutes 40-50% by weight of the total formulation, facilitating dissolution and homogenization of the precursors.

In accordance with an embodiment of the present invention, the titanium-containing precursor is synthesized through a reaction involving tetra butyl titanate (TBOT), acetic acid, and acetylacetone in a molar ratio of 1:3:1, contributing to the formation of polydiacetictitanium (PDET) as a source of titanium.

In accordance with an embodiment of the present invention, the titanium-containing and silicon-containing precursors are combined in a molar ratio of 3:1, balancing thermal insulation and flexibility in the resulting nanofibrous membranes.

In accordance with an embodiment of the present invention, the polymeric binder comprises polyethylene oxide with a molecular weight of approximately 1,000,000, facilitating spinnability and uniform distribution of nanofibers.

In accordance with an embodiment of the present invention, the titanium-containing precursor is concentrated and re-dissolved in methanol to form a golden-red solution prior to incorporation into the formulation.

In accordance with an embodiment of the present invention, the nanofibrous membranes exhibit thermal conductivity of no more than 0.032 W/m.K at room temperature, ensuring effective insulation.

In accordance with an embodiment of the present invention, the nanofibrous membranes demonstrate a tensile strength of at least 4 MPa after heat treatment, enabling reliable performance in insulation applications.

In accordance with an embodiment of the present invention, the solvent system includes a mixture of methanol and glacial acetic acid in a volume ratio of 4:1, optimizing solubility and preventing premature gelation.

In accordance with an embodiment of the present invention, the heat treatment process involves heating the precursor nanofibers to 700° C. at a rate of 5° C./min and holding for 2 hours, forming thermally stable nanofibrous membranes.

Another embodiment of the present invention relates to a method for preparing flexible ceramic nanofibers for thermal insulation applications. The method includes synthesizing a titanium-containing precursor through a reaction involving a titanium source, an organic acid, and a chelating agent, wherein the reaction is conducted under controlled conditions to ensure the formation of a precursor with reactive functional groups, including terminal alkenes, present in a molar ratio of 50-70%. The method also includes dissolving the titanium-containing precursor in an alcohol-based solvent system comprising methanol and glacial acetic acid to create a homogenous solution. The method also includes introducing a silicon-containing precursor with hydrolysable alkoxy groups into the solution to enhance flexibility and thermal resistance. The method also includes incorporating a polymeric binder selected from polyethylene oxide to provide spinnability and structural uniformity during electrospinning. The method also includes electrospinning the prepared solution under controlled environmental parameters, including a spinning voltage, needle-to-collector distance, and advancing syringe speed, to produce precursor nanofibers. The method also includes subjecting the precursor nanofibers to a heat treatment process, wherein the nanofibers are heated to a temperature range of 600-700° C. at a controlled heating rate, facilitating the removal of organic components and the formation of thermally stable ceramic nanofibrous membranes.

In accordance with an embodiment of the present invention, the titanium-containing precursor is aged after synthesis to enhance gel network strength, improving the stability of the nanofibers during the electrospinning and heat treatment processes.

In accordance with an embodiment of the present invention, the electrospinning process is performed using a stainless-steel needle of gauge 25, a spinning voltage of 15 kV, and a syringe advancement speed of 2 mL/h to achieve consistent nanofiber morphology.

In accordance with an embodiment of the present invention, the environmental parameters for electrospinning are controlled to maintain a relative humidity of 45-55% and a temperature of 25° C., minimizing fiber defects and enhancing uniformity.

In accordance with an embodiment of the present invention, the nanofibers are collected on a rotating drum during electrospinning to align the fibers and improve the mechanical properties of the resulting membranes.

In accordance with an embodiment of the present invention, the heat treatment process includes a cooling phase after reaching 700° C., allowing the nanofibers to naturally cool to room temperature to prevent thermal shock and ensure structural integrity.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 illustrates a flowchart of a formulation for preparing flexible ceramic nanofibers for thermal insulation applications, in accordance with an embodiment of the present invention;

FIG. 2 illustrates a flowchart of a method for preparing flexible ceramic nanofibers for thermal insulation applications, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### The Following Brief Definition of Terms Shall Apply Throughout the Present Invention

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

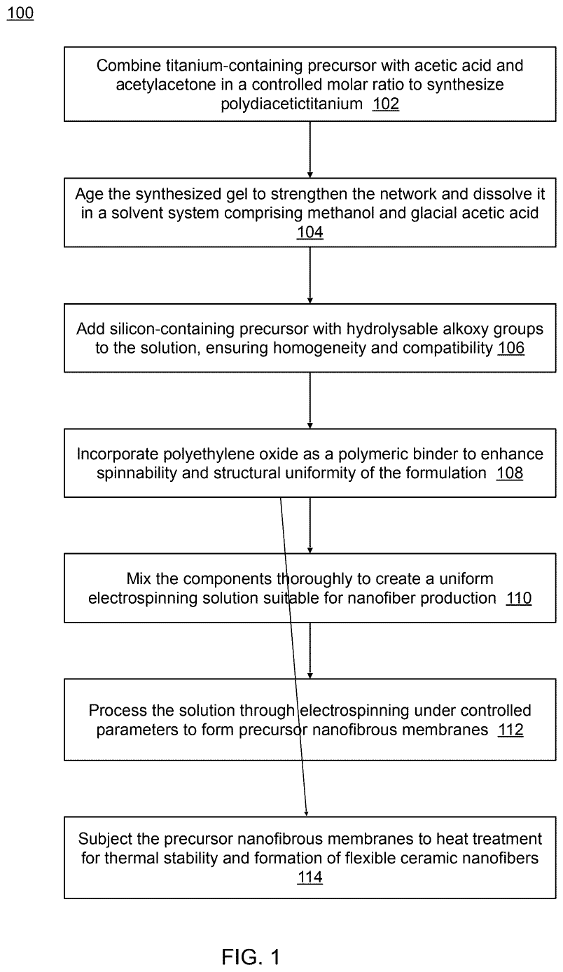

FIG. 1 illustrates a flowchart of a formulation for preparing flexible ceramic nanofibers for thermal insulation applications 100, in accordance with an embodiment of the present invention.

The formulation 100 may comprise a titanium-containing precursor comprising reactive functional groups, including terminal alkenes, present in a molar ratio of 50-70% relative to the total precursor solution, facilitating further radical polymerization and segment integration. The formulation 100 may include a silicon-containing precursor comprising hydrolysable alkoxy groups, contributing to enhanced thermal resistance and flexibility. The formulation 100 may also include a polymeric binder selected from polyethylene oxide, providing spinnability and structural uniformity during electrospinning. The formulation 100 may also include a solvent system comprising alcohol-based solvents and glacial acetic acid, promoting solubility and homogeneity of the components, wherein upon processing through electrospinning and subsequent heat treatment, produces nanofibrous membranes with low thermal conductivity, high tensile strength, and adaptability for thermal insulation applications in aerospace, electronics, and flexible insulation fields.

The titanium-containing precursor constitutes 30-40% by weight of the total formulation, ensuring optimal thermal stability and mechanical performance.

The silicon-containing precursor constitutes 15-20% by weight of the total formulation, enhancing structural flexibility and insulation properties.

The polymeric binder comprises polyethylene oxide, present in an amount of 0.5-1.5% by weight, ensuring uniform fiber formation during electrospinning.

The solvent system, including methanol and glacial acetic acid, constitutes 40-50% by weight of the total formulation, facilitating dissolution and homogenization of the precursors.

The titanium-containing precursor is synthesized through a reaction involving tetra butyl titanate (TBOT), acetic acid, and acetylacetone in a molar ratio of 1:3:1, contributing to the formation of polydiacetictitanium (PDET) as a source of titanium.

The titanium-containing and silicon-containing precursors are combined in a molar ratio of 3:1, balancing thermal insulation and flexibility in the resulting nanofibrous membranes.

The polymeric binder comprises polyethylene oxide with a molecular weight of approximately 1,000,000, facilitating spinnability and uniform distribution of nanofibers.

The titanium-containing precursor is concentrated and re-dissolved in methanol to form a golden-red solution prior to incorporation into the formulation.

The nanofibrous membranes exhibit thermal conductivity of no more than 0.032 W/m.K at room temperature, ensuring effective insulation.

The nanofibrous membranes demonstrate a tensile strength of at least 4 MPa after heat treatment, enabling reliable performance in insulation applications.

The solvent system includes a mixture of methanol and glacial acetic acid in a volume ratio of 4:1, optimizing solubility and preventing premature gelation.

The heat treatment process involves heating the precursor nanofibers to 700° C. at a rate of 5° C./min and holding for 2 hours, forming thermally stable nanofibrous membranes.

The method 100 may comprise synthesizing a titanium-containing precursor through a reaction involving a titanium source, an organic acid, and a chelating agent, wherein the reaction is conducted under controlled conditions to ensure the formation of a precursor with reactive functional groups, including terminal alkenes, present in a molar ratio of 50-70%. The method 100 may include dissolving the titanium-containing precursor in an alcohol-based solvent system comprising methanol and glacial acetic acid to create a homogenous solution. The method 100 may also include introducing a silicon-containing precursor with hydrolysable alkoxy groups into the solution to enhance flexibility and thermal resistance. The method 100 may also include incorporating a polymeric binder selected from polyethylene oxide to provide spinnability and structural uniformity during electrospinning. The method 100 may also include electrospinning the prepared solution under controlled environmental parameters, including a spinning voltage, needle-to-collector distance, and advancing syringe speed, to produce precursor nanofibers. The method 100 may also include subjecting the precursor nanofibers to a heat treatment process, wherein the nanofibers are heated to a temperature range of 600-700° C. at a controlled heating rate, facilitating the removal of organic components and the formation of thermally stable ceramic nanofibrous membranes.

The titanium-containing precursor is aged after synthesis to enhance gel network strength, improving the stability of the nanofibers during the electrospinning and heat treatment processes.

The electrospinning process is performed using a stainless-steel needle of gauge 25, a spinning voltage of 15 kV, and a syringe advancement speed of 2 mL/h to achieve consistent nanofiber morphology.

The environmental parameters for electrospinning are controlled to maintain a relative humidity of 45-55% and a temperature of 25° C., minimizing fiber defects and enhancing uniformity.

The nanofibers are collected on a rotating drum during electrospinning to align the fibers and improve the mechanical properties of the resulting membranes.

The heat treatment process includes a cooling phase after reaching 700° C., allowing the nanofibers to naturally cool to room temperature to prevent thermal shock and ensure structural integrity.

The formulation for preparing flexible ceramic nanofibers for thermal insulation applications is developed by combining specifically selected materials and processes to ensure superior thermal and mechanical performance. The formulation comprises a titanium-containing precursor, a silicon-containing precursor, a polymeric binder, and a solvent system, each contributing specific functional roles. The titanium-containing precursor contains reactive functional groups, including terminal alkenes, present in a molar ratio of 50 to 70 percent relative to the total precursor solution. This molar ratio ensures optimal reactivity for radical polymerization, enabling efficient integration of additional segments during processing. The silicon-containing precursor, with hydrolysable alkoxy groups, enhances the thermal resistance and flexibility of the nanofibers, ensuring their adaptability for high-temperature applications.

The titanium-containing precursor is synthesized through a reaction involving tetra butyl titanate, acetic acid, and acetylacetone, conducted under controlled conditions. This reaction produces polydiacetictitanium, which acts as a source of titanium for the formulation. The synthesized gel undergoes an aging process to strengthen the gel network and improve stability during subsequent processing stages. The gel is then dissolved in a solvent system comprising methanol and glacial acetic acid to create a uniform and homogeneous solution. The silicon-containing precursor is introduced into this solution to enhance the compatibility and interaction between components, resulting in a robust hybrid mixture.

The polymeric binder selected for this formulation is polyethylene oxide, which ensures spinnability and structural uniformity during the electrospinning process. Polyethylene oxide is incorporated in an amount ranging from 0.5 to 1.5 percent by weight of the total formulation, facilitating the formation of uniform nanofibers. The solvent system, comprising methanol and glacial acetic acid in a ratio of 4:1, promotes solubility and homogenization of the precursors while preventing premature gelation. This carefully designed combination of materials and conditions ensures the production of high-quality nanofibrous membranes with consistent properties.

The electrospinning process is carried out under specific environmental and operational parameters to produce nanofibers with uniform morphology. The prepared solution is electro spun using a stainless-steel needle with a gauge of 25, under a voltage of 15 kilovolts, and with a syringe advancement speed of two milliliters per hour. The distance between the needle and the collecting drum is maintained at twenty centimeters, ensuring uniform deposition of nanofibers on the drum. The relative humidity is controlled between 45 to 55 percent, and the temperature is maintained at 25 degrees Celsius to minimize defects and enhance fiber uniformity. The collected precursor nanofibers are subjected to a heat treatment process to enhance their thermal stability and mechanical properties.

The heat treatment process involves heating the precursor nanofibers at a controlled rate, first to 600 degrees Celsius at one degree per minute, and then to 700 degrees Celsius at five degrees per minute. The nanofibers are held at 700 degrees Celsius for two hours to remove organic components and form thermally stable ceramic nanofibers. The nanofibers are then naturally cooled to room temperature to prevent thermal shock and ensure structural integrity. The resulting nanofibrous membranes exhibit low thermal conductivity and high tensile strength, making them suitable for a variety of thermal insulation applications.

The titanium-containing precursor constitutes 30 to 40 percent by weight of the total formulation, ensuring thermal stability and mechanical performance. The silicon-containing precursor constitutes 15 to 20 percent by weight, enhancing the flexibility and insulation properties of the nanofibers. The solvent system, including methanol and glacial acetic acid, constitutes 40 to 50 percent by weight, facilitating dissolution and homogenization of the precursors. The precise ratios and reaction conditions are carefully optimized to ensure the formulation's effectiveness and reliability.

The nanofibrous membranes produced using this formulation demonstrate exceptional performance characteristics. The thermal conductivity of the membranes is no more than 0.032 watts per meter-kelvin at room temperature, ensuring effective insulation. The tensile strength of the membranes is at least 4 megapascals after heat treatment, enabling reliable performance in demanding applications. These properties make the formulation ideal for use in aerospace, electronics, and flexible insulation materials, addressing the need for high-performance thermal insulation solutions.

The synthesis of the titanium-containing precursor involves a molar ratio of 1:3:1 for tetra butyl titanate, acetic acid, and acetylacetone. This ratio facilitates the formation of polydiacetictitanium, which is subsequently concentrated and re-dissolved in methanol to form a golden-red solution. This step ensures homogeneity and enhances the compatibility of the precursor with other components in the formulation. The titanium-containing and silicon-containing precursors are combined in a molar ratio of 3:1, balancing thermal insulation and flexibility in the final product.

The formulation ensures compatibility and interaction between the titanium-containing precursor, the silicon-containing precursor, the polymeric binder, and the solvent system. The specific ratios and processing conditions are designed to produce nanofibers with consistent properties and high performance. The nanofibers are versatile and adaptable, with applications ranging from high-temperature insulation materials to advanced aerospace components. The combination of low thermal conductivity, high tensile strength, and flexibility makes the formulation a significant advancement in the field of thermal insulation materials.

This formulation addresses the limitations of existing insulation materials by providing a solution that combines superior thermal resistance, mechanical strength, and adaptability. The flexible ceramic nanofibers produced using this formulation offer significant advantages in terms of performance and versatility. The use of advanced characterization techniques, including thermal conductivity measurements, tensile strength tests, and thermogravimetric analysis, validates the reliability and effectiveness of the nanofibers in various applications.

The development of this formulation represents a major improvement over existing technologies, offering a unique combination of properties that meet the demands of modern thermal insulation applications. The careful selection of materials and optimization of processing conditions ensure the scalability and reproducibility of the formulation, making it suitable for industrial-scale production. The formulation provides a reliable and efficient solution for addressing the growing demand for high-performance thermal insulation materials in a wide range of industries.

The development of flexible ceramic nanofibers for high-temperature thermal insulation involves a meticulous formulation and processing method to achieve membranes with low thermal conductivity, excellent mechanical properties, and the ability to withstand temperatures up to 1200° C. The formulation integrates carefully selected components that contribute to the uniformity, stability, and performance of the final nanofibrous membranes. The inclusion of a titanium-containing precursor enriched with reactive functional groups, such as terminal alkenes, facilitates radical polymerization and segment integration. This component plays a pivotal role in enhancing the thermal stability and mechanical properties of the membranes.

The silicon-containing precursor, which includes hydrolysable alkoxy groups, contributes to the thermal resistance and flexibility of the membranes. This precursor ensures that the membranes can maintain their structural integrity under high temperatures, making them suitable for applications in aerospace, electronics, and flexible insulation fields. The polymeric binder, selected from polyethylene oxide with a molecular weight of approximately 1,000,000, provides spinnability and structural uniformity during the electrospinning process. The binder ensures that the fibers maintain consistent morphology and distribution, which is critical for achieving the desired performance characteristics.

The synthesis of the titanium-containing precursor involves a reaction between tetra butyl titanate (TBOT), acetic acid, and acetylacetone in a molar ratio of 1:3:1. This reaction is conducted under controlled conditions, including an ice bath, to ensure the formation of polydiacetictitanium (PDET). The PDET is then aged to reinforce the gel network, improving its stability and performance during subsequent processing steps. The aged precursor is dissolved in an alcohol-based solvent system comprising methanol and glacial acetic acid. This solvent system promotes solubility and homogeneity, ensuring that all components are uniformly mixed.

The addition of the silicon-containing precursor to the titanium-containing precursor solution creates a hybrid TiO2/SiO2 solution. The integration of these precursors in a molar ratio of 3:1 balances the thermal insulation and flexibility of the resulting nanofibrous membranes. The solution is further homogenized with the addition of polyethylene oxide and stirred to ensure complete dissolution. This step is crucial for producing defect-free nanofibers with consistent thermal conductivity and tensile strength.

Electrospinning is performed under strictly controlled environmental parameters to ensure consistent fiber morphology. The spinning voltage is set at 15 kV, and the advancing syringe speed is maintained at 2 mL/h. The distance between the stainless-steel needle and the collecting drum is 20 cm, and the temperature is controlled at 25° C. with a relative humidity of 45-55%. These conditions minimize defects and enhance the uniformity of the fibers. The fibers are collected on a rotating drum, which aligns the fibers and improves the mechanical properties of the membranes.

The precursor nanofibers undergo a heat treatment process that involves gradual heating to 600° C. at a rate of 1° C./min, followed by heating to 700° C. at a rate of 5° C./min. This process facilitates the removal of organic components and the formation of thermally stable ceramic structures within the nanofibers. The membranes are held at 700° C. for 2 hours and then naturally cooled to room temperature. This controlled heating and cooling process prevents thermal shock and ensures the structural integrity of the nanofibers.

Characterization of the nanofibrous membranes involves several key tests to validate their performance. The thermal conductivity is measured using the transient hot wire technique, confirming that the membranes exhibit a thermal conductivity of no more than 0.032 W/m.K at room temperature. Tensile strength tests are conducted using a T150 UTM monofilament tensile testing machine, revealing a tensile strength of at least 4 MPa after heat treatment. These results demonstrate the membranes' suitability for high-performance thermal insulation applications.

The thermogravimetric analysis provides insights into the mass loss of the membranes when heated to 1200° C. This test confirms the thermal stability of the membranes and their ability to retain structural integrity at high temperatures. The membranes are also subjected to heating tests in a ceramic furnace at 1200° C. for 4 hours, which further validates their thermal resistance. These tests highlight the membranes' adaptability for use in extreme environments, such as aerospace and electronics.

The solvent system, comprising methanol and glacial acetic acid in a volume ratio of 4:1, optimizes the dissolution of the precursors and prevents premature gelation. This system ensures that the components remain homogenous throughout the electrospinning process. The use of polyethylene oxide as a polymeric binder enhances the spinnability of the formulation, allowing for the production of uniform nanofibers. The binder also contributes to the flexibility of the membranes, making them suitable for applications requiring adaptable insulation materials.

The titanium-containing precursor undergoes a series of preparation steps to ensure its compatibility with the other components. After synthesis, the precursor is concentrated and re-dissolved in methanol to form a golden-red solution. This solution is then combined with the silicon-containing precursor and the polymeric binder to create a homogenous formulation. The precise control of the preparation and mixing processes ensures the reproducibility and scalability of the formulation, making it suitable for large-scale production.

The hybrid TiO2/SiO2 nanofibrous membranes exhibit unique properties that set them apart from existing insulation materials. Their low thermal conductivity ensures effective insulation, while their high tensile strength allows them to withstand mechanical stresses. These properties make the membranes ideal for use in industries requiring high-performance thermal insulation materials. The flexibility of the membranes further enhances their applicability, allowing them to be used in applications where rigid materials would fail to perform effectively.

In addition to their thermal and mechanical properties, the nanofibrous membranes demonstrate excellent adaptability for various applications. Their ability to maintain structural integrity at high temperatures and under mechanical stress makes them suitable for use in aerospace, electronics, and other demanding environments. The membranes' unique combination of properties ensures that they can meet the requirements of modern insulation applications, providing a reliable and effective solution for high-temperature environments.

The formulation incorporates carefully balanced molar ratios for each precursor to optimize the properties of the resulting nanofibrous membranes. The titanium-containing precursor, enriched with reactive functional groups, interacts effectively with the silicon-containing precursor to form a stable hybrid network. This interaction ensures that the nanofibers exhibit a uniform distribution of thermal and mechanical properties across their structure. The polymeric binder plays a critical role in maintaining the uniformity and integrity of the fibers during the electrospinning process, ensuring that the nanofibers maintain consistent morphology and performance characteristics.

The titanium-containing precursor is synthesized through a stepwise process, involving controlled reactions with acetic acid and acetylacetone. This approach not only stabilizes the precursor but also introduces terminal alkenes, which enhance its reactivity during polymerization. The inclusion of acetylacetone as a chelating agent ensures the formation of polydiacetictitanium with consistent structural properties. The synthesized precursor undergoes an aging process to reinforce the gel network, improving its overall stability and performance during subsequent processing steps. This aged precursor is critical in achieving the desired tensile strength and thermal stability in the final nanofibrous membranes.

The solvent system is designed to achieve complete dissolution of all components and prevent premature gelation during processing. Methanol and glacial acetic acid are combined in precise ratios to provide an ideal medium for the dissolution of the precursors and the polymeric binder. The solvent system facilitates uniform mixing and ensures the homogeneity of the formulation. This step is crucial for producing defect-free nanofibers with consistent thermal conductivity and tensile strength. The solvent system also contributes to the ease of scalability, making the formulation suitable for large-scale production in industrial applications.

Electrospinning, as utilized in this formulation, is performed under strictly controlled conditions to ensure consistent fiber morphology. The selection of a stainless-steel needle with a specific gauge, combined with a carefully controlled voltage, ensures uniform deposition of fibers onto the rotating drum collector. The precise control of environmental factors such as temperature and humidity minimize defects in the fibers and enhances their structural uniformity. This method results in nanofibers with superior mechanical properties, making them highly suitable for use in high-temperature and high-stress environments.

At 102, combine titanium-containing precursor with acetic acid and acetylacetone in a controlled molar ratio to synthesize polydiacetictitanium.

At 104, age the synthesized gel to strengthen the network and dissolve it in a solvent system comprising methanol and glacial acetic acid.

At 106, add silicon-containing precursor with hydrolysable alkoxy groups to the solution, ensuring homogeneity and compatibility.

At 108, incorporate polyethylene oxide as a polymeric binder to enhance spinnability and structural uniformity of the formulation.

At 110, mix the components thoroughly to create a uniform electrospinning solution suitable for nanofiber production.

At 112, process the solution through electrospinning under controlled parameters to form precursor nanofibrous membranes.

At 114, subject the precursor nanofibrous membranes to heat treatment for thermal stability and formation of flexible ceramic nanofibers.

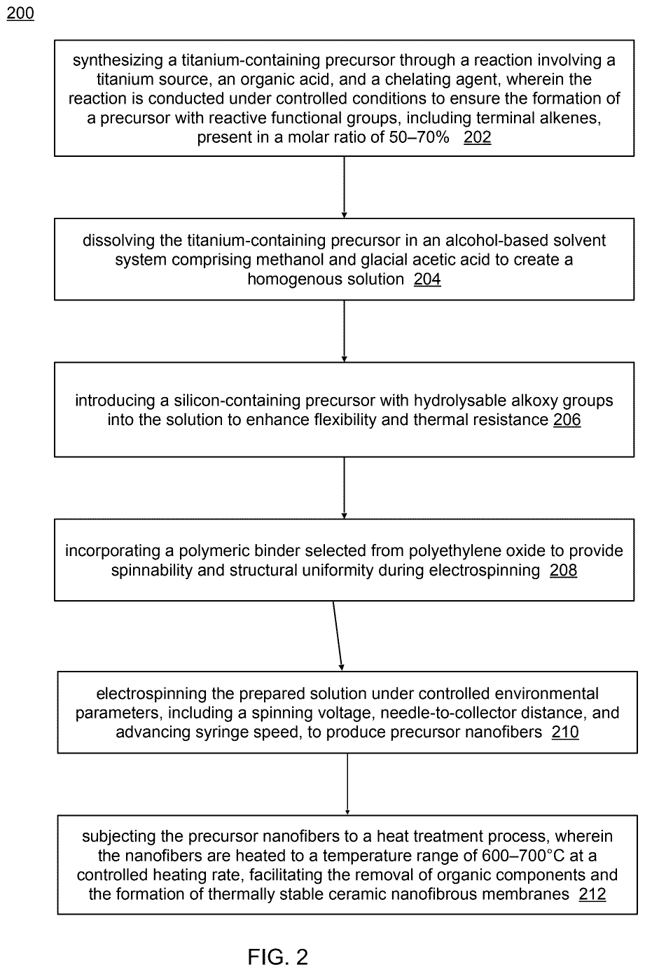

FIG. 2 illustrates a flowchart of a method for preparing flexible ceramic nanofibers for thermal insulation applications, in accordance with an embodiment of the present invention.

At 202, synthesizing a titanium-containing precursor through a reaction involving a titanium source, an organic acid, and a chelating agent, wherein the reaction is conducted under controlled conditions to ensure the formation of a precursor with reactive functional groups, including terminal alkenes, present in a molar ratio of 50-70%.

At 204, dissolving the titanium-containing precursor in an alcohol-based solvent system comprising methanol and glacial acetic acid to create a homogenous solution.

At 206, introducing a silicon-containing precursor with hydrolysable alkoxy groups into the solution to enhance flexibility and thermal resistance.

At 208, incorporating a polymeric binder selected from polyethylene oxide to provide spinnability and structural uniformity during electrospinning.

At 210, electrospinning the prepared solution under controlled environmental parameters, including a spinning voltage, needle-to-collector distance, and advancing syringe speed, to produce precursor nanofibers.

At 212, subjecting the precursor nanofibers to a heat treatment process, wherein the nanofibers are heated to a temperature range of 600-700° C. at a controlled heating rate, facilitating the removal of organic components and the formation of thermally stable ceramic nanofibrous membranes.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A formulation for preparing flexible ceramic nanofibers for thermal insulation applications, the formulation comprising:
a titanium-containing precursor comprising reactive functional groups, including terminal alkenes, present in a molar ratio of 50-70% relative to the total precursor solution, facilitating further radical polymerization and segment integration;
a silicon-containing precursor comprising hydrolysable alkoxy groups, contributing to enhanced thermal resistance and flexibility;
a polymeric binder selected from polyethylene oxide, providing spinnability and structural uniformity during electrospinning;
a solvent system comprising alcohol-based solvents and glacial acetic acid, promoting solubility and homogeneity of the components, wherein upon processing through electrospinning and subsequent heat treatment, produces nanofibrous membranes with low thermal conductivity, high tensile strength, and adaptability for thermal insulation applications in aerospace, electronics, and flexible insulation fields.

2. The formulation of claim 1, wherein the titanium-containing precursor constitutes 30-40% by weight of the total formulation, ensuring optimal thermal stability and mechanical performance.

3. The formulation of claim 1, wherein the silicon-containing precursor constitutes 15-20% by weight of the total formulation, enhancing structural flexibility and insulation properties.

4. The formulation of claim 1, wherein the polymeric binder comprises polyethylene oxide, present in an amount of 0.5-1.5% by weight, ensuring uniform fibre formation during electrospinning.

5. The formulation of claim 1, wherein the solvent system, including methanol and glacial acetic acid, constitutes 40-50% by weight of the total formulation, facilitating dissolution and homogenization of the precursors.

6. The formulation of claim 1, wherein the titanium-containing precursor is synthesized through a reaction involving tetra butyl titanate (TBOT), acetic acid, and acetylacetone in a molar ratio of 1:3:1, contributing to the formation of polydiacetictitanium (PDET) as a source of titanium.

7. The formulation of claim 1, wherein the titanium-containing and silicon-containing precursors are combined in a molar ratio of 3:1, balancing thermal insulation and flexibility in the resulting nanofibrous membranes.

8. The formulation of claim 1, wherein the polymeric binder comprises polyethylene oxide with a molecular weight of approximately 1,000,000, facilitating spinnability and uniform distribution of nanofibers.

9. The formulation of claim 1, wherein the titanium-containing precursor is concentrated and re-dissolved in methanol to form a golden-red solution prior to incorporation into the formulation.

10. The formulation of claim 1, wherein the nanofibrous membranes exhibit thermal conductivity of no more than 0.032 W/m.K at room temperature, ensuring effective insulation.

11. The formulation of claim 1, wherein the nanofibrous membranes demonstrate a tensile strength of at least 4 MPa after heat treatment, enabling reliable performance in insulation applications.

12. The formulation of claim 1, wherein the solvent system includes a mixture of methanol and glacial acetic acid in a volume ratio of 4:1, optimizing solubility and preventing premature gelation.

13. The formulation of claim 1, wherein the heat treatment process involves heating the precursor nanofibers to 700° C. at a rate of 5° C./min and holding for 2 hours, forming thermally stable nanofibrous membranes.

14. The method for preparing flexible ceramic nanofibers for thermal insulation applications, the method comprising:
synthesizing a titanium-containing precursor through a reaction involving a titanium source, an organic acid, and a chelating agent, wherein the reaction is conducted under controlled conditions to ensure the formation of a precursor with reactive functional groups, including terminal alkenes, present in a molar ratio of 50-70%;
dissolving the titanium-containing precursor in an alcohol-based solvent system comprising methanol and glacial acetic acid to create a homogenous solution;
introducing a silicon-containing precursor with hydrolysable alkoxy groups into the solution to enhance flexibility and thermal resistance;
incorporating a polymeric binder selected from polyethylene oxide to provide spinnability and structural uniformity during electrospinning;
electrospinning the prepared solution under controlled environmental parameters, including a spinning voltage, needle-to-collector distance, and advancing syringe speed, to produce precursor nanofibers;
subjecting the precursor nanofibers to a heat treatment process, wherein the nanofibers are heated to a temperature range of 600-700° C. at a controlled heating rate, facilitating the removal of organic components and the formation of thermally stable ceramic nanofibrous membranes.

15. The method of claim 14, wherein the titanium-containing precursor is aged after synthesis to enhance gel network strength, improving the stability of the nanofibers during the electrospinning and heat treatment processes.

16. The method of claim 14, wherein the electrospinning process is performed using a stainless-steel needle of gauge 25, a spinning voltage of 15 kV, and a syringe advancement speed of 2 mL/h to achieve consistent nanofiber morphology.

17. The method of claim 14, wherein the environmental parameters for electrospinning are controlled to maintain a relative humidity of 45-55% and a temperature of 25° C., minimizing fiber defects and enhancing uniformity.

18. The method of claim 14, wherein the nanofibers are collected on a rotating drum during electrospinning to align the fibers and improve the mechanical properties of the resulting membranes.

19. The method of claim 14, wherein the heat treatment process includes a cooling phase after reaching 700° C., allowing the nanofibers to naturally cool to room temperature to prevent thermal shock and ensure structural integrity.
